(19) United States
(12) Patent Application Publication
(10) Pub. No.: US 2012/0092672 A1
(43) Pub. Date: Apr. 19, 2012

(54) Method and Apparatus for Detecting Overlapped Substrates

(76) Inventors: Leon Saltsov, Thornhill (CA); Bogdan Mishunin, Toronto (CA); Dimitro Baydin, Toronto (CA); Volodymyr Barchuk, Toronto (CA); Mykhaylo Bazhenov, Kiev (UA); Olga Bazhenova, Kiev (UA); Oleksandr Soyfer, Vinnitsa (AU)

(21) Appl. No.: 11/922,885

(22) PCT Filed: Jun. 28, 2006
(86) PCT No.: PCT/CA2006/001054

§ 371 Date: Nov. 12, 2009

(30) Foreign Application Priority Data
Jun. 28, 2005 (CA) 2,510,943

(51) Int. Cl. G01N 21/86

(52) U.S. Cl. 356/432

(57) ABSTRACT

An apparatus and method for detection of overlapped substrates, that are at least opaque, analyses a high frequency component caused by speckle for a sudden drop therein. This high frequency component drops dramatically when overlapped substrates are present and therefore allows fast accurate recognition of an overlapped substrate condition. This is useful in many applications including banknote validators.

### FIELD OF THE INVENTION

The present application is directed to a method and apparatus for detecting overlapped substrates being moved past an optical sensor. In particular, the method and apparatus include a passage for transmitting single substrates past an optical sensor designed to detect the presence of overlapped substrates in such a series of single substrates.

### BACKGROUND OF THE INVENTION

In many document handling systems, documents such as banknotes, cheques, cards, vouchers and the like, are transported one by one along a transport path for analysis and processing. The document handling system includes sensors to identify information provided on the document and to supply this information to a processing means for determining how the document is to be processed.

An undesirable situation may occur when two or more documents are fed to the system at the same time. This situation is known as a double feed document condition and it is desirable to detect this condition and reject or reprocess the documents to eliminate the condition.

There are a number of known mechanical and optical systems for detecting the double feed document condition. One known mechanical technique effectively uses mechanical means to contact the substrates and determine a thickness or change in thickness thereof. Examples of these techniques are shown in U.S. Pat. No. 3,679,202; U.S. Pat. No. 4,550,252 and U.S. Pat. No. 5,704,246. Basically, the thickness of the documents in double feed document condition is greater than some predetermined standard and an alarm or stop signal is produced. This known technique is difficult to use for thin documents and/or for documents having a variable thickness as is often the case with used banknotes. For example, with used banknotes the banknotes May be creased or laminated with scotch tape for example, making the thickness determination more difficult. Furthermore, with these type of mechanical thickness based structures it is difficult to maintain the sensitivity of the measurement arrangement due to vibration, wear, dirt variation in banknote condition and other factors which will occur during prolonged use of the device.

Optical double detection systems such as disclosed in U.S. Pat. No. 5,341,408; U.S. Pat. No. 5,502,312 and U.S. Pat. No. 5,581,354 use at least one light emitter and a corresponding light detector positioned on the opposite side of the passage through which the documents are transported. The light emitter generates a beam of light which passes through the document in the passageway and the transmitted light is detected by the light detector. The light detector produces an output signal which is a function of the light absorption and light scattering of the document between the light emitter and the light detector. The output signal is calibrated by various means to a normal condition against which the actual received conditions are compared. When a double feed document condition occurs the double thickness of the document significantly reduces the received light and a sudden decreases in the signal is used to determine a double feed document condition.

These prior art double feed detection systems are sensitive to variations caused by different paper, varying surface color patterns and creases and folds in the substrate. Variation will also occur due to deterioration of the circuitry, voltage variation over time and substrate placement in the passageway. Due to these variations the systems require ongoing adjustment of the preset signals of the light emitter and the light detector. Unfortunately, these systems have low dynamic range. Basically the systems are measuring the amount of light which is transmitted through the document or substrate and the amount of light can significantly vary due to black marks or logos provided on the document, the number of folds or creases in the paper and/or the position of the document within the passageway. Furthermore, worn and dirty single documents may be more opaque than a double condition of two new documents.

U.S. Pat. No. 5,222,729 discloses a method and apparatus for detecting superimposed sheets of paper. This system utilizes cooperating upper and lower laser emitter and photo receiver pairs that are positioned above and below the sheet transport path. Voltages that are representative of the positions of the upper and lower surfaces of the sheet are compared to assigned values. If the actual values significantly exceed the assigned values, a superimposed sheet condition signal is produced and appropriate corrective action can be taken. This technique is complicated and requires substantial processing. It is difficult to use it for crumpled and blazed documents.

The simple detection of has been difficult to achieve particularly in a device which can be quickly calibrated without substantial and time consuming operator involvement. Also it has been difficult to achieve a detection arrangement which is reliable and accurately identifies double feed document conditions.

The present invention seeks to overcome a number of these deficiencies.

### SUMMARY OF THE PRESENT INVENTION

A method of detecting the occurrence of overlapped substrates in a succession of single substrates being moved past an optical sensor comprises exposing each substrate as it is moved past the optical senor to culminated coherent light where a portion of the light is transmitted through the substrate and received by a photo detector which produces an output signal where the output signal where the output signal has a low frequency component proportional to an average transmitted light through the substrate and a high frequency speckle flicker component produced by the rough surface and movement of the substrate past the optical sensor. The method includes monitoring the high frequency speckle flicker component for a sudden drop in the level thereof reflective of the reduced high frequency component created when overlapped substrates move past the optical sensor.

According to an aspect of the invention the method includes using the optical sensor to determine a first adaptive threshold as a predetermined amount of the average signal from the photo detector when no document is present and using the first adaptive threshold as a reference to determine a change in signal indicative of a substrate being moved past the optical sensor.

In yet a further aspect of the invention the method includes setting a second adaptive threshold as a predetermined amount of the high frequency speckle flicker component during transport of a single substrate past the optical sensor.

In yet a further aspect of the invention the method includes automatic changeover from the first adaptive threshold to the second adaptive threshold for each substrate as it is moved past the optical sensor.

In yet a further aspect of the invention the method includes using a photo detector having a narrow aperture to produce the output signal.

In yet a further aspect of the invention the method includes amplifying the output signal prior to monitoring the high frequency speckle flicker component.

### BRIEF DESCRIPTION OF THE DRAWINGS

The above as well as other advantages and features of the present invention will be described in greater detail according to the preferred embodiments of the present invention in which;

FIG. 1 is a schematic view showing a substrate being moved past the optical senor;

FIG. 2 is a schematic view illustrating the type of signal produced when two substrates are moved past the optical sensor;

FIG. 3 is a schematic view showing the optical sensor either side of a substrate passageway;

FIG. 4 shows a circuit diagram used in the processing of the signals;

FIG. 5 is a double graph showing the signals produced when a single hundred dollar currency document is moved past the optical sensor and the signal when a double condition occurs with two hundred dollar banknotes being moved past the optical sensor in an overlapped condition; and

FIG. 6 is a graph similar to FIG. 5 showing a single document and a double document with dark markings being provided on the single document.

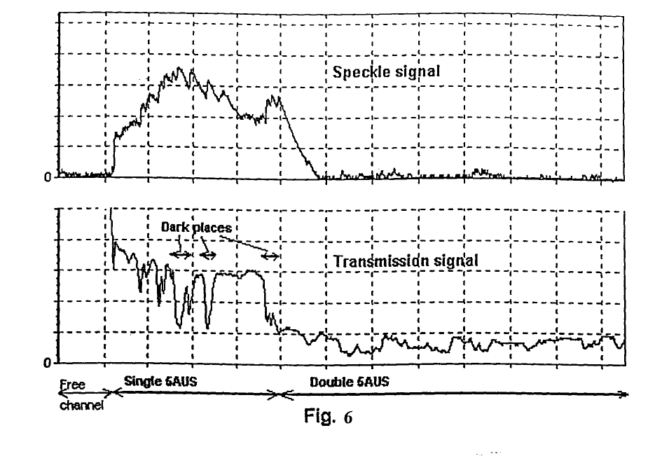

### DETAILED DESCRIPTION ACCORDING TO THE PREFERRED EMBODIMENTS OF THE PRESENT INVENTION IN WHICH

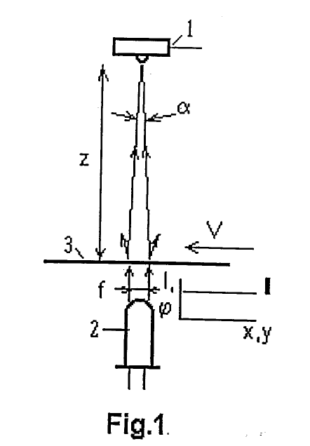

The present invention recognizes that the high frequency speckle component from an optical sensor is greatly effected when two banknotes are placed between the optical sensor. Basically, a laser or other light source produces a collimated light exposing one side of a banknote as it is moved past the optical sensor. A photo detector is provided on the opposite side of the passageway and receives light which is transmitted through the document. The surface of the banknote or other substrates are relatively rough and produce constructive light interference and destructive light interference. This would be true of the light reflected from the banknote and it is also true of the light which is transmitted through the banknote. Basically the rough surface of the substrate produces this interference. Speckle flicker is produced due to the constructive interference and this constructive interference effectively appears to move due to the movement of the banknote. Analysis of the output signal received from the photo detector produces a low frequency component due to of the transmitted light as well as a high frequency speckle flicker component produced by the constructive interference with the surface of the banknote or other document. When two substrates are present as illustrated in FIG. 1B the high frequency speckle flicker component is essentially eliminated or greatly reduced. Thus monitoring of the high frequency speckle flicker component and noting a sudden drop therein is indicative of a double substrate condition.

FIG. 1A illustrates a speckle image acquisition from single document, and FIG. 1B illustrates a speckle image acquisition from doubled document. In all illustrations the photo detector is marked as 1, laser emitter as 2, single banknote as 3, superimposed banknote as 4, V—speed of banknote movement, f—laser beam diameter near banknote, z—distance between banknote and photo detector, α—maximum observation angle of illuminated spot on banknote. Insets on FIG. 1 shows coordinate (x and y is the same) dependence of illuminated beam intensity (I) and phase (φ)). Inset | describes quasi-uniform laser beam illuminated first banknote 3 surface. Inset ∥ describes strongly non-uniform luminous flux after first banknote 3 which illuminates superimposed banknote 4. Under quasi-uniform laser illumination the maximum speckle flicker frequency F is about F=V·f/λ·z, where λ is the laser wavelength. Under typical values V=300 mm/sec, f=1.2 mm, λ=850 nm, z=20 mm the upper speckle flicker frequency is F≈20 kHz and speckle flicker frequency band is in the range of 1 to 20 kHz. The superimposed banknote 4 is illuminated by strongly non-uniform flux—speckle image after first banknote 3 with typical spot size up to hundreds times less than laser beam. As a result the maximum speckle flicker frequency and light coherency strongly decreases, so speckle signal from doubled banknote falls dramatically (by a factor of 10 or greater).

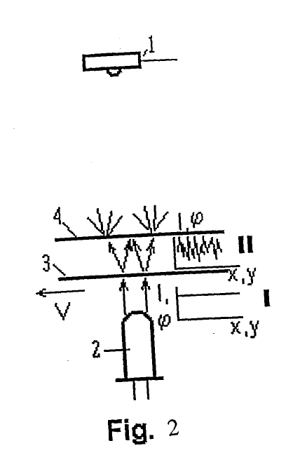

FIG. 2 is a side view of an example of single sensing assembly construction. The linear IC compact photosensor S7815 from Hamamatsu is used as photodetector 1. VCSEL compact IR laser SV4637-001 from Honeywell is used as emitter 2. Photo detector is mounted on PC board 6 with electronic components 5. Emitter 2 is mounted on separate mini PC board 10 on the other side of passageway formed by upper 7 and lower 8 walls with transparent windows 9. Typical banknote transporting speed for specified assembly is in the range 50 to 2000 mm/sec. In order to increase the banknote speed a faster detector with smaller sensing active area would be used.

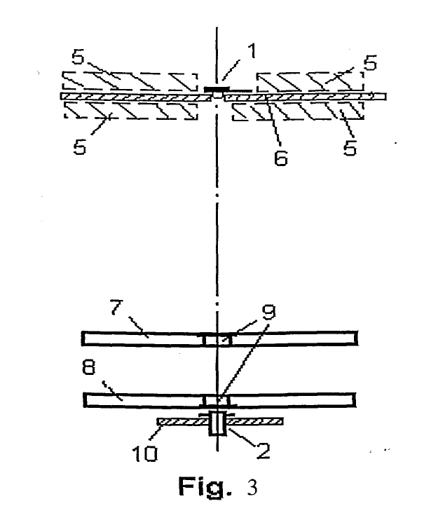

FIG. 3 shows a block diagram of hardware components processing of speckle flicker signal in a single sensing assembly. In order to take the calibration signal from free channel and corresponding first adaptive threshold, laser emitter 2 is constantly pumping from generator 11 by pulses with duty factor 1/32. Photo detector 1 at that time generates average signal (because of photo detector vision persistence) proportional to total transmission of free channel, windows 9 etc. Typical the signal for the embodiment shown on FIG. 2 lies in the range 4 to 6 V. Upper frequency band alternating component of said signal is amplified by upper-frequency amplifier 14 and detected by linear detector 15. Typical detector output signal under said conditions lies in the range 2 to 3 V. A predetermined fraction (typically 1/5) of the signal (generally set by resistors R1, R2) is used as first adaptive threshold. When the banknote enters the sensing assembly (between laser and photo detector) photo detector output average signal significantly falls (commonly lowers 1.5 V) and comparator 13 with reference Vᵣ₁ switch on the key cell 12. The laser 2 is switched into steady generation mode.

The banknote moving between the laser and the photo detector causes the output signal of the photo detector to have a steady component (proportional for average banknote transmission) and alternating component (proportional for speckle flicker). The upper frequency band (speckle flicker component) of said alternating component again is amplified by upper-frequency amplifier 14 and detected by linear detector 15. Typical the detector output speckle flicker signal lies in the range 0, 0.8 to 3 V depending on banknote type and condition. A predetermined fraction (typically ¼) of the signal (generally set by resistors R4, R5) is used as second adaptive threshold.

Changeover time from first threshold to second adaptive threshold is dependent on the characteristic time of R4C4. When detector 15 output signal strongly drops below the first or second threshold (it is typical for doubled banknote) comparator 17 produces inhibiting negative pulse. The delay circuit R6C5 and comparator 18 is used to inhibiting pulse time exceeding the transport mechanism stop and/or crash-back time. In order to eliminate error signals from banknote with wide opaque places (like blazed hologram on EURO and new 100CD) the increase of detector 15 integration time is provided by connection additional capacity C3 with key cell 16.

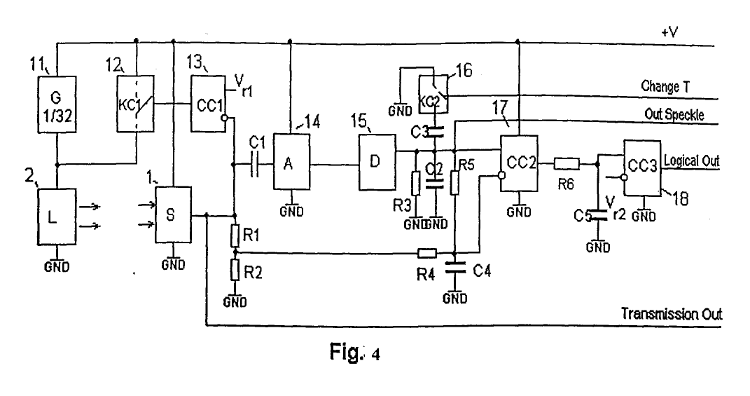

FIG. 4 shows a typical signals under steady laser illumination of double banknote with blazed hologram 100CD which are shifted with space displacement about 50 mm. Scale factor for abscissa axis is 40 msec/point and 0.5 V/point for ordinate axis. So up to 25 msec from beginning signals corresponds for free channel, from 25 msec to 160 msec—for single banknote, from 160 msec to the end—for double banknote. In order to produce a more pure consistent speckle flicker the signal laser emitter produces a steady emission. Banknote movement speed is about 300 mm/sec. The speckle signal is reflective of the time dependence of detected speckle flicker signal with banknote movement. The transmission signal describes the time dependence of average banknote transmission at the same point.

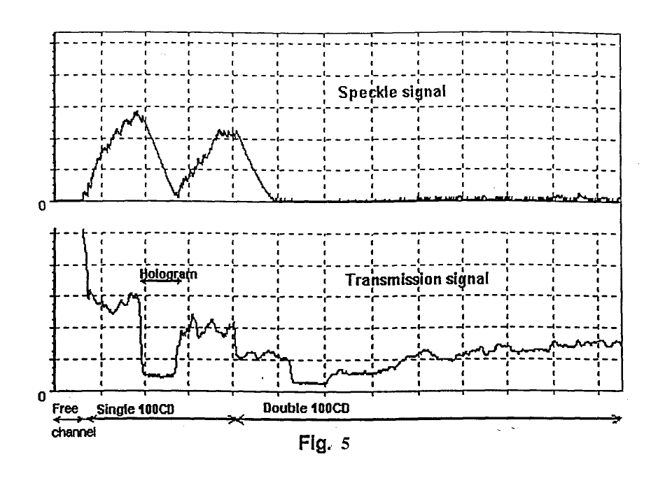

FIG. 5 shows a typical signal under steady laser illumination of a double banknote condition where the banknotes include a plastic substrate and a dark surface pattern 5 or Australian Dollars. The scale factor is the same as in FIG. 4. So up to 50 msec from beginning signals corresponds for free channel, from 50 msec to 200 msec—for single banknote, from 200 msec to the end—for double banknote. In order to produce a more consistent speckle flicker signal the laser emitter produces steady emission. Banknote movement speed is about 300 mm/sec. The speckle signal describes the time dependence of detected speckle flicker signal with banknote movement. The transmission signal describes the time dependence of average banknote transmission at the same point.

The present invention is described herein in the context of a double banknote checking application as for bill feeder, bill dispenser or other bills handling device, in a bank, postal facility, supermarket, casino or transportation facility. However, it is appreciated that the embodiment shown and described herein may also be useful for checking other doubled substrates, particularly flat, substrates such as cards, films, paper sheets and paintings. The checking device may be stationary or portable, battery powered or powered by connection to an electric outlet.

This arrangement is particularly suitable for banknote validators that include an inlet for receiving a stack of banknotes.

It is appreciated that various features of the invention, which are, for clarity, described in the context of single embodiment, may also be provided in combination in series or another embodiments. Conversely, various features of the invention which are, for brevity, described in the context of a single embodiment, may also be provided separately or in any suitable combination.

Although various preferred embodiments of the present invention have been described in detail, it will be appreciated by those skilled in the art that variations may be made without departing from the spirit of the invention or the scope of the appended claims.

The embodiments of the invention in which an exclusive property or privilege is claimed are defined as follows:

1. A method of detecting the occurrence of overlapped substrates in a succession of single substrates being moved past an optical sensor, said method comprising
exposing each substrate as it is moved past the optical sensor to a collimated coherent light where a portion of the light is transmitted through said substrate and received by a photo detector and an output signal is produced where the output signal has a low frequency component proportional average transmitted light through the substrate and a high frequency speckle flicker component produced by the rough surface and movement of the substrate past the optical sensor,
monitoring said high frequency speckle flicker component for a sudden drop in the level thereof reflective of the reduced high frequency component created when overlapped substrates move past said optical sensor.

2. A method as claimed in claim 1 wherein said method includes using said optical sensor to determine a first adaptive threshold as a predetermined amount of the average signal from the photo detector when no substrate is present and using said first adaptive threshold to determine a change in signal indicative of a substrate being moved past said optical sensor.

3. A method as claimed in claim 2 including setting a second adaptive threshold as a predetermined amount of the high frequency speckle flicker component during single substrate passage said optical sensor.

4. A method as claimed in claim 3 including automatic changeover from the first adaptive threshold to the second adaptive threshold after passing a predetermined fore-part of the substrate.

5. A method as claimed in claim 1 including using a photo detector having a narrow aperture to produce the output signal.

6. A method as claimed in claim 1 including amplifying the output signal prior to monitoring said high frequency speckle flicker component.

7. A method as claimed in claim 1 including comparing said high frequency speckle flicker component to a predetermined standard when a substrate is passing the optical sensor and producing an overlapped substrate signal when the high frequency speckle flicker component falls below said predetermined standard.

8. A method as claimed in claim 1 wherein each substrate is exposed to collimated coherent light produced by a laser.

9. A method as claimed in claim 8 including processing the output signal and determining a correlation between average output signal of the photo detector and the high frequency speckle flicker component.

10. A method claimed in claim 1 wherein the substrates are transported past the optical sensor at a speed in the range of 50 to 2000 mm/sec.

11. An apparatus for detecting the occurrence of overlapped substrates in a succession of substrates being moved past an optical sensor, said method comprising
exposing each substrate as it is moved past the optical sensor to a collimated coherent light where a portion of the light is transmitted through said substrate and received by a photo detector, said photo detector producing an output signal having a low frequency component proportional average transmitted light through the substrate and a high frequency speckle flicker component produced by a rough surface of the substrate and movement of the substrate past the optical sensor,
a processing arrangement processing the high frequency speckle flicker component to determine a sudden drop in the level thereof indicative of the reduced high frequency component created when overlapped substrates move past said optical sensor.

12. An apparatus as claimed in claim 11 including a stop arrangement for interrupting the movement of the substrates when a sudden drop in the high frequency speckle flicker component is determined.

13. An apparatus as claimed in claim 11 wherein said processing arrangement includes a first adaptive threshold as a predetermined fraction of the average signal from the photo detector when no substrate is present and using said first adaptive threshold to determine a change in signal indicative of a substrate being moved past said optical sensor.

14. An apparatus as claimed in claim 13 wherein said processing arrangement including setting a second adaptive threshold as a predetermined amount of the high frequency speckle flicker component during passage of a single substrate past said optical sensor.

15. An apparatus as claimed in claim 14 including an automatic changeover arrangement from the first adaptive threshold to the second adaptive threshold after passing a predetermined initial portion of a substrate post said optical sensor.

16. An apparatus as claimed in claim 1 wherein said photo detector has a narrow aperture to produce the output signal.

17. An apparatus as claimed in claim 12 wherein said processing arrangement includes an amplifier for amplifying the output signal prior to processing the high frequency speckle flicker component.
